(19) United States
(12) Patent Application Publication
(10) Pub. No.: US 2024/0177052 A1
(43) Pub. Date: May 30, 2024

(54) ENHANCING DEPLOYED MACHINE LEARNING MODELS USING PROMPT LEARNING

(71) Applicant: INTERNATIONAL BUSINESS MACHINES CORPORATION, ARMONK, NY (US)

(72) Inventors: Zhong Fang Yuan, Xi'an (CN); Tong Liu, Xi'an (CN); Si Tong Zhao, Beijing (CN); Xiang Yu Yang, Xi'an (CN); Shi Bo Yan, Xi'an (CN)

(21) Appl. No.: 18/059,531

(22) Filed: Nov. 29, 2022

(51) Int. Cl. G06N 20/00; G06F 18/22

(52) U.S. Cl. CPC G06N 20/00; G06F 18/22

(57) ABSTRACT

A method, computer system, and a computer program product for enhancing deployed machine learning (ML) models using prompt learning is provided. The present invention may include receiving an input for a prediction task using a first ML model. The present invention may also include adding a feature to the received input using a second ML model, where the added feature is recognized by the first ML model. The present invention may further include predicting, using the first ML model, an output for the received input based on the added feature, wherein the predicted output by the first ML model based on the added feature includes an improved accuracy relative to another predicted output by the first ML model without considering the added feature.

### BACKGROUND

The present invention relates generally to the field of computing, and more particularly to prompt-based machine learning.

Various deployed machine learning (ML) models may include legacy ML models developed based on now outdated methods and technologies. These legacy ML models may be deployed online, and thus may be difficult to replace for several reasons. For example, many legacy ML models may run on mission-critical nodes, such as bank settlement systems and airline scheduling systems. These computing systems may require 24-hour continuous operation of its deployed legacy ML models to support extremely high task densities. As such, these computing systems may not be able to withstand the risks posed by any downtime for replacing, debugging, and/or upgrading legacy ML models. Moreover, many intermediate results of these legacy ML models may be linked to the processes of other ML models or computing systems. If a legacy ML model is completely replaced, the replacement may cause a domino effect of other system failures. However, as technology continues to develop, legacy ML models that have been deployed and are unable to be replaced and/or upgraded may become a greater bottleneck for computing performance.

### SUMMARY

Embodiments of the present invention disclose a method, computer system, and a computer program product for enhancing deployed machine learning (ML) models using prompt learning. The present invention may include receiving an input for a prediction task using a first ML model. The present invention may also include adding a feature to the received input using a second ML model, where the added feature is recognized by the first ML model. The present invention may further include predicting, using the first ML model, an output for the received input based on the added feature, wherein the predicted output by the first ML model based on the added feature includes an improved accuracy relative to another predicted output by the first ML model without considering the added feature.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computing environment according to at least one embodiment;

FIG. 2 is a schematic block diagram of a machine learning environment according to at least one embodiment;

FIG. 3 is a schematic block diagram of a model fine-tuning environment according to at least one embodiment; and

FIG. 4 is an operational flowchart illustrating a prompt-learning process according to at least one embodiment.

### DETAILED DESCRIPTION

The following described exemplary embodiments provide a system, method, and computer program product for enhancing deployed machine learning (ML) models using prompt learning. As such, the present embodiment has the capacity to improve the technical field of prompt-based ML by implementing knowledge pre-extraction and feature alignment techniques using an external ML model to enhance a legacy ML model for downstream tasks. More specifically, a prompt learning program may receive an input for a prediction task using a first ML model. Then, the prompt learning program may implement a second ML model to add a feature to the received input, where the added feature may be recognized by the first ML model. Thereafter, the prompt learning program may implement the first ML model to predict an output for the received input based on the added feature. In one embodiment, the predicted output by the first ML model based on the added feature may include an improved accuracy relative to another predicted output by the first ML model without considering the added feature.

As described previously, various deployed ML models may include legacy ML models developed based on now outdated methods and technologies. These legacy ML models may be deployed online, and thus may be difficult to replace for several reasons. For example, many legacy ML models may run on mission-critical nodes, such as bank settlement systems and airline scheduling systems. These computing systems may require 24-hour continuous operation of its deployed legacy ML models to support extremely high task densities. As such, these computing systems may not be able to withstand the risks posed by any downtime for replacing, debugging, and/or upgrading legacy ML models. Moreover, many intermediate results of these legacy ML models may be linked to the processes of other ML models or computing systems. If a legacy ML model is completely replaced, the replacement may cause a domino effect of other system failures. However, as technology continues to develop, legacy ML models that have been deployed and are unable to be replaced and/or upgraded may become a greater bottleneck for computing performance.

Therefore, it may be advantageous to, among other things, provide a way to improve the performance of a deployed (e.g., online) ML model without modifying and/or replacing the deployed ML model. It may be advantageous to improve the performance of the deployed ML model by enhancing (e.g., enriching) an input of the deployed ML model by prompting an external ML model to add a feature to the input of the deployed ML model that exists in a pre-defined answer space and is recognized by the deployed ML model as learned feature that is highly directional. The enriched input may be human-readable and highly interpretable. Embodiments of the present disclosure provides advantageous solutions based on the characteristics of prompt learning to solve the problem of improving the functionality of deployed ML models.

The enhancement to the deployed ML model may be derived from the training dataset of the deployed ML model, which may enable the deployed ML model to make predictions in a comfort zone of deployed ML model. The deployed ML model may be enhanced with the technical abilities of the latest pre-trained language model without making major changes to the deployed ML model. Any subsequent upgrades to the deployed ML model may be performed by upgrading the prompt learning of the pre-trained language model. The enhancement to the deployed ML model may be completely decoupled from the deployed ML model. Thus, the enhancement to the deployed ML model may be a pluggable enhancement and may be replaced according to a given situation.

According to one embodiment, for each piece of data that needs to be predicted by a deployed ML model, the prompt learning program may implement prompt learning to enhance the data by adding one or more features (e.g., new text fragments) to the original data. In one embodiment, these new text fragments may be selected from a training dataset of the deployed ML model that needs to be functionally improved. In the training process of the deployed ML model, the accuracy rate of nearly 100% may be obtained in the training dataset. Thus, the new text fragments selected from the training dataset of the deployed ML model may be highly directional. The new text fragments may greatly enhance the data that needs to be predicted and increase the probability of being correctly identified by the deployed ML model. As such, the disclosed embodiments may move the accuracy bottleneck from the deployed ML model, which may include a legacy ML model, to the prompt learning process of a pre-trained language model.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), crasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

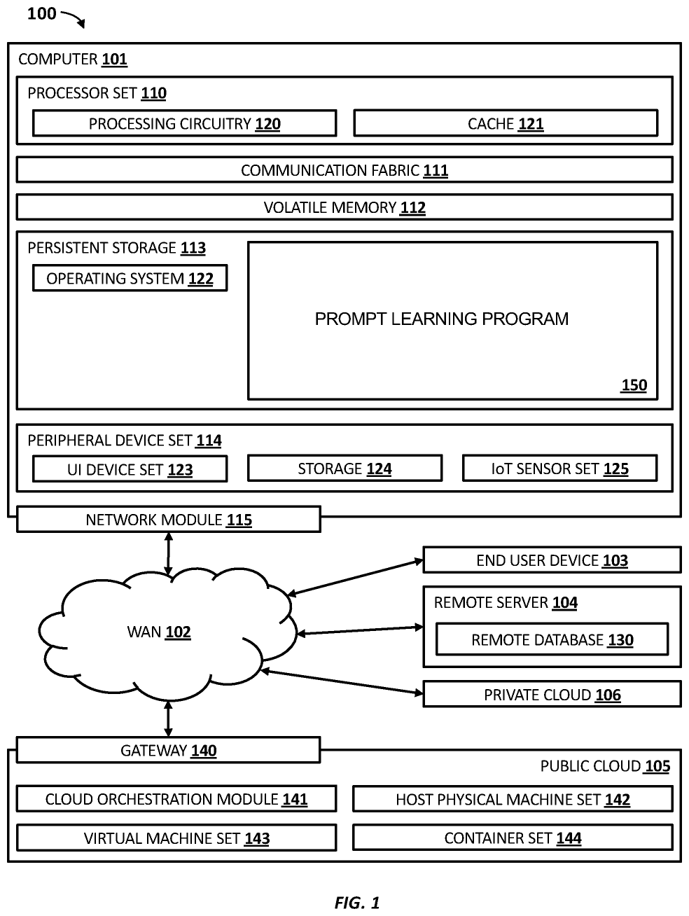

Referring to FIG. 1, a computing environment 100 according to at least one embodiment is depicted. Computing environment 100 contains an example of an environment for the execution of at least some of the computer code involved in performing the inventive methods, such as prompt learning program 150. In addition to prompt learning program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and prompt learning program 150, as identified above), peripheral device set 114 (including user interface (UI), device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144. Furthermore, despite only being depicted in computer 101, prompt learning program 150 may be stored in and/or executed by, individually or in any combination of, EUD 103, remote server 104, public cloud 105, and private cloud 106.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 (e.g., prompt learning program 150) in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The prompt learning program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth® (Bluetooth and all Bluetooth-based trademarks and logos are trademarks or registered trademarks of Bluetooth SIG, Inc. and/or its affiliates) connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

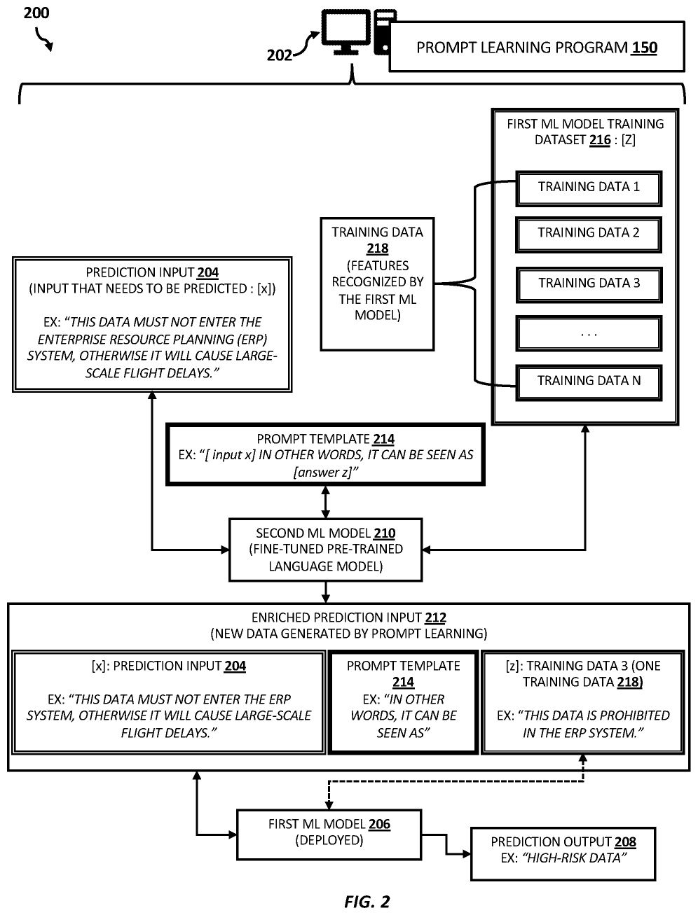

According to the present embodiment, a user using any combination of an EUD 103, remote server 104, public cloud 105, and private cloud 106 may use the prompt learning program 150 to implement a prompt learning process to improve the performance of a first machine learning (ML) model using a second ML model without changing and/or replacing the first ML model. Embodiments of the present disclosure are explained in more detail below with respect to FIGS. 2 to 4.

Referring now to FIG. 2, a schematic block diagram of an ML environment 200 according to at least one embodiment is depicted. According to one embodiment, the ML environment 200 may include a computer system 202 having a tangible storage device and a processor that is enabled to run the prompt learning program 150.

Generally, the computer system 202 may be enabled by the prompt learning program 150 to implement ML techniques to generate improved predictions from a deployed ML model associated with new input data, without training the deployed ML model on the new input data.

According to one embodiment, the computer system 202 may include one or more components (e.g., computer 101; end user device (EUD) 103; WAN 102) of the computer environment 100 described above with reference to FIG. 1. In one embodiment, the computer system 202 may include one or more computers (e.g., computer 101) which may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, and/or querying a database.

According to one embodiment, aspects of the computer system 202 may operate in a cloud computing service model, such as Software as a Service (Saas), Platform as a Service (PaaS), or Infrastructure as a Service (IaaS). In one embodiment, the computer system 202 may also be implemented as a cloud computing deployment model, such as a private cloud, community cloud, public cloud, or hybrid cloud.

In one embodiment, the prompt learning program 150 may include a single computer program or multiple program modules or sets of instructions being executed by the processor of the computer system 202. In one embodiment, the prompt learning program 150 may include routines, objects, components, units, logic, data structures, and actions that may perform particular tasks or implement particular abstract data types. In one embodiment, the prompt learning program 150 may be practiced in distributed cloud computing environments where tasks may be performed by local and/or remote processing devices which may be linked through a communication network (e.g., WAN; LAN; telecommunication network; wireless network; public switched network and/or satellite network). In at least one embodiment, the prompt learning program 150 (e.g., the various modules) may be executed on a single computing device.

According to one embodiment, the prompt learning program 150 may receive a prediction input 204. In one embodiment, the prediction input 204 may include an input for an ML task (e.g., prediction task) to be performed using a first ML model 206. In one embodiment, the prompt learning program 150 may receive the prediction input 204 from a user via an EUD 103. In other embodiments, the prompt learning program 150 may receive the prediction input 204 from the user via any combination of computer 101, remote server 104, public cloud 105, and private cloud 106.

According to one embodiment, the first ML model 206 may refer to an ML model that is deployed (e.g., deployed ML model; online ML model) in the ML environment 200. In one embodiment, the first ML model 206 may be stored in and/or executed by, individually or in any combination of, computer 101, EUD 103, remote server 104, public cloud 105, and private cloud 106. In one embodiment, the first ML model 206 may refer to a legacy ML model. In one embodiment, the first ML model 206 may include a natural language processing (NLP) model and/or a computer-vision model. In various embodiments, non-limiting examples of the first ML model 206 may implement ML techniques, such as Extreme Gradient Boosting (XGBoost), fastText, and/or support vector machines (SVMs).

According to one embodiment, the first ML model 206 may include one or more limitations that may decrease the accuracy of a prediction output 208 for the received prediction input 204. For example, the first ML model 206 may not perform well on prediction tasks that include unstructured data inputs (e.g., prediction input 204). In another example, the first ML model 206 may not perform well on prediction tasks that include inputs (e.g., prediction input 204) having negative words (e.g., not, can't, don't, won't, never) that negate a concept or meaning of the input. Therefore, the ML environment 200 may advantageously include a second ML model 210 which may be implemented by the prompt learning program 150 to generate an enriched prediction input 212. It is contemplated that the enriched prediction input 212 may improve an accuracy of the prediction output 208 of the first ML model 206 by including one or more features that may be recognized by the first ML model 206 and may be predictive of the prediction output 208. In one embodiment, as will be further detailed below, the prompt learning program 150 may implement prompt-based learning in conjunction with the second ML model 210 to generate the features which may help the first ML model 206 to output the prediction (e.g., prediction output 208) associated with the prediction input 204.

According to one embodiment, the second ML model 210 may include a pre-trained language model (e.g., NLP model). In various embodiments, non-limiting examples of the second ml model 210 may include, a Generative Pre-trained Transformer 3 (GPT-3), GPT-2, ERNIE, NEural contextualiZed representation for CHinese IAnguage understanding (NEZHA), and/or Text-To-Text Transfer Transformer (T-5). In one embodiment, the second ml model 210 may be stored in and/or executed by, individually or in any combination of, computer 101, EUD 103, remote server 104, public cloud 105, and private cloud 106.

According to one embodiment, the prompt learning program 150 may leverage the knowledge of the second ml model 210 and a natural language prompt to perform an NLP task using the second ml model 210 without any task-specific training. The NLP tasks may include tasks, such as, for example, text generation, text classification, information extraction, and/or text analysis. In one embodiment, the prompt learning program 150 may formulate the natural language prompt as a prompt template 214. In one embodiment, the prompt template 214 may be manually generated (e.g., by a prompt engineer) and/or automatically generated (e.g., by ML techniques). In one embodiment, the prompt template 214 may be stored in and/or executed by, individually or in any combination of, computer 101, EUD 103, remote server 104, public cloud 105, and private cloud 106. In one embodiment, the prompt template 214 may include at least one first slot for one or more inputs (e.g., prediction input 204), as denoted by the “[x]” in FIG. 2, and/or at least one second slot for one or more potential answers, as denoted by the “[z]” in FIG. 2.

According to one embodiment, the prompt learning program 150 may implement the prompt template 214 to perform the NLP task of text generation. More specifically, the prompt learning program 150 may instruct the second ml model 210, using the prompt template 214, to generate text that is a synonym of the prediction input 204. In one embodiment, the synonym of the prediction input 204 may include data that is semantically similar to the prediction input 204. In one embodiment, the synonym may not lose any of the semantic features of the prediction input 204. In one embodiment, two or more semantically similar data may include the same or similar meaning (e.g., rephrase, paraphrase, summary). In one embodiment, semantic similarity between two or more data may be measured a distance between the data (e.g., represented as an embedding) in a vector space model.

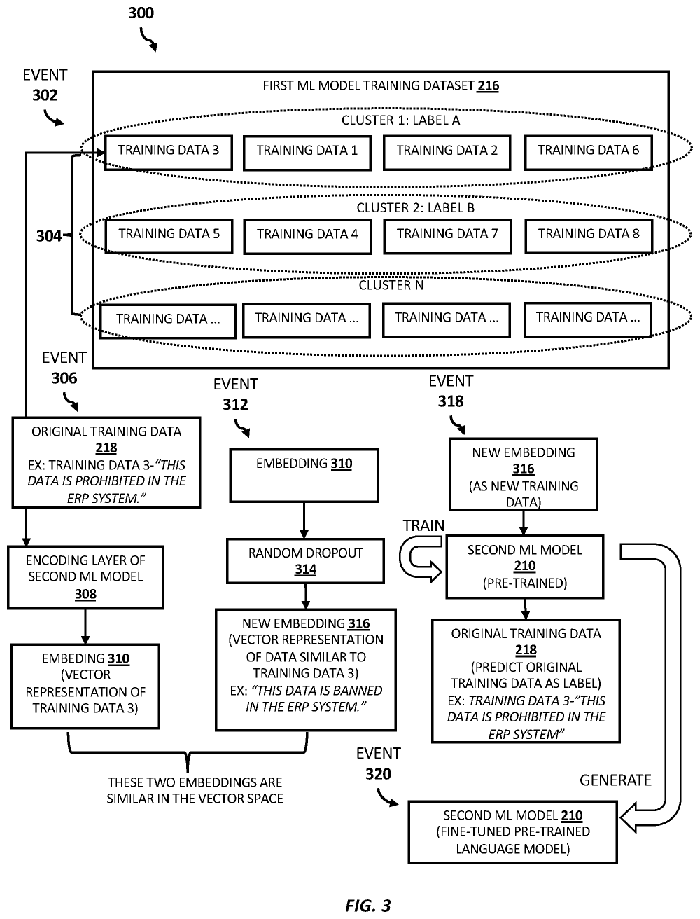

Therefore, in embodiments of the present disclosure, the prompt learning program 150 may modify the prompt template 214 to include the prediction input 204 as the input [x]. Then, the prompt learning program 150 may implement the prediction input 204, together with the natural-language prompt in the prompt template 214, to instruct the second ml model 210 to output the synonym (e.g., semantically similar data) of the prediction input 204 as the answer [z]. It is contemplated that the synonym of the prediction input 204 may help the first ML model 206 in generating the prediction output 208 if the synonym is recognized and/or learned by the first ML model 206. Accordingly, the prompt learning program 150 may pre-define, for the second ml model 210, the possible values for the answer [z] (e.g., answer space), as a first ML model training dataset 216. In other words, the first ML model training dataset 216 may include a set of answers [Z] for the second ml model 210. As such, the prompt learning program 150 may implement the second ml model 210 to select a training data 218 from the first ML model training dataset 216 as the answer [z] (e.g., semantically similar data relative to the prediction input 204). In at least one embodiment, the second ml model 210 may be fine-tuned to select the semantically similar data (e.g., answer [z]) relative to the prediction input 204 from the first ML model training dataset 216. One embodiment of the fine-tuning process is detailed further with reference to FIG. 3.

In one embodiment, the first ML model training dataset 216 may be stored in and/or executed by, individually or in any combination of, computer 101, EUD 103, remote server 104, public cloud 105, and private cloud 106. In one embodiment, the training data 218 may refer to any of the training data (e.g., training data 1, training data 2, training data 3, . . . , training data N) in the first ML model training dataset 216.

As illustrated in FIG. 2, one example of the prediction input 204 (e.g., input that needs to be predicted by the first ML model 206) may include the following text: “This data must not enter the Enterprise Resource Planning (ERP) system, otherwise it will cause large-scale flight delays.” Continuing with the previous example, the prompt learning program 150 may define the prompt template 214 as “[x] In other words, it can be seen as [z].” Then, the prompt learning program 150 may modify the prompt template 214 to include the prediction input 204 (e.g., “This data must not enter the Enterprise Resource Planning (ERP) system, otherwise it will cause large-scale flight delays. In other words, it can be seen as [z].”) and implement the second ML model 210 (e.g., fine-tuned pre-trained language model) to receive and/or retrieve the modified prompt template 214. In at least one embodiment, the prompt learning program 150 may implement the second ML model 210 to receive and/or retrieve the prediction input 204 and the prompt template 214 separately, and then modify the prompt template 214 to include the prediction input 204.

Continuing with the previous example, the second ML model 210 may determine the NLP task of semantically similar text generation based on the natural-language description of the task in the modified prompt template 214. Since the second ML model 210 is fined-tuned to generate the answer [2] from the first ML model training dataset 216, the second ML model 210 may search for one of the training data 218 in the first ML model training dataset 216 as being semantically similar to the prediction input 204. In this example, the second ML model 210 may rank the various training data 218 and map the prediction input 204 to training data 3 (e.g., “This data is prohibited in the ERP system.”) as being semantically similar (e.g., closest in the vector space). In one embodiment, training data 3 (e.g., answer [z]) may include one or more features and associated label that may be recognized by the first ML model 206.

Continuing with the previous example, the prompt learning program 150 may implement the second ML model 210 to receive and/or retrieve the training data 3 and generate the enriched prediction input 212 (e.g., new data generated by prompt learning). In one embodiment, the enriched prediction input 212 may be generated by adding the training data 3 (e.g., one of the training data 218) to the answer [z] slot of the prompt template 214 including the prediction data 204 in the input [x] slot. In one embodiment, the enriched prediction input 212 may be stored in and/or executed by, individually or in any combination of, computer 101, EUD 103, remote server 104, public cloud 105, and private cloud 106. In this example, the enriched prediction input 212 may include the following text: “This data must not enter the Enterprise Resource Planning (ERP) system, otherwise it will cause large-scale flight delays. In other words, it can be seen as this data is prohibited in the ERP system.” In one embodiment, generating the enriched prediction input 212 may include adding one or more features (e.g., of training data 3) to the prediction input 204 that may be recognized by the first ML model 206.

Continuing with the previous example, in one embodiment, the prompt learning program 150 may implement the first ML model 206 to receive and/or retrieve the enriched prediction input 212 and generate the prediction output 208 (e.g., “high-risk data”). In one embodiment, the first ML model 206 may recognize training data 3 (e.g., the features of the training data 3) in the enriched prediction input 212 and may generate the prediction output 208 based on the recognized features (and associated label) of training data 3. In this example, the features of training data 3 may be associated with the label “high-risk data.” Therefore, the first ML model 206 may generate the prediction output 208 as “high-risk data.”

Continuing with the previous example, in another embodiment, the prompt learning program 150 may implement the first ML model 206 to receive and/or retrieve the answer [z] as the input to the first ML model 206. In this embodiment, the first ML model 206 may receive and/or retrieve the training data 3 (e.g., the features of the training data 3) without the other components of the enriched prediction input 212 (e.g., the prompt template 214 including the prediction input 204) since the prediction input 204 and training data 3 were determined to be semantically similar. Thereafter, the first ML model 206 may recognize training data 3 (e.g., the features of the training data 3) in the input and may generate the prediction output 208 based on the recognized features (and associated label “high-risk data”) of training data 3.

Referring now to FIG. 3, a schematic block diagram of an exemplary model fine-tuning environment 300 used by the prompt learning program 150 according to at least one embodiment is depicted. FIG. 3 provides a description of model fine-tuning environment 300 with reference to the ML environment 200 (FIG. 2).

As described previously with reference to FIG. 2, the prompt learning program 150 may pre-define the possible values for the answer space (e.g., answer [z]) in the prompt template 214 as the first ML model training dataset 216. In this way, the first ML model 206 may recognize the features in the answer space, which may help the first ML model 206 understand the meaning of the prediction input 204 and generate the prediction output 208 based on the recognized features in the answer space.

According to one embodiment, while the second ML model 210 may be capable of generating semantically similar data (e.g., answer [z]) relative to the prediction input 204, the prompt learning program 150 may fine-tune the second ML model 210 such that the second ML model 210 may select the answer [z] (e.g., in the prompt template 214) from the first ML model training dataset 216. In one embodiment, fine-tuning the second ML model 210 may refer to training the pre-trained language model (e.g., second ML model 210) on a new dataset for a specific task.

According to one embodiment, at event 302, the prompt learning program 150 may divide the first ML model training dataset 216 into one or more clusters of training data 304 based on the label associated with the training data in each cluster of training data 304. For example, the one or more training data in cluster 1 may each be associated with the label A and the one or more training data in cluster 2 may each be associated with the label B. In one embodiment, the first ML model training dataset 216 may be divided into any number of clusters (e.g., cluster N) where each cluster of training data 304 may include any number of training data. In one embodiment, the prompt learning program 150 may fine-tune the second ML model 210 by training the second ML model 210 using each of the one or more clusters of training data 304. In one embodiment, several rounds of training may be performed in each cluster of training data 304.

According to one embodiment, at event 306, in each round of training the prompt learning program 150 may randomly select a training data 218 (e.g., original/historical training data) from each cluster (e.g., each cluster of training data 304) of the first ML model training dataset 216. In one embodiment, the prompt learning program 150 may pass the training data 218 through an encoding layer 308 (e.g., of the second ML model 210) to generate an embedding 310 (e.g., vector representation) of the training data 218. In one embodiment, the embedding 310 or vector representation may refer to a numerical representation of the training data 218 that captures the semantic meaning of the training data 218.

For example, the prompt learning program 150 may select training data 3 (“This data is prohibited in the ERP system.”) from cluster 1 of the first ML model training dataset 216 and may pass the training data 3 through the encoding layer 308 to generate the embedding 310 of the training data 3. In one embodiment, the embedding 310 may include a vector representation of training data 3.

According to one embodiment, at event 312, the prompt learning program 150 may apply a random dropout technique 314 to the embedding 310 to generate a new embedding 316 that is similar to the embedding 310 in a vector space. In one embodiment, the random dropout technique 314 may remove (e.g., set to 0) one or more units in the numerical representation of the embedding 310 to create the new embedding 316 (e.g., with a different numerical representation) that is still semantically similar (e.g., a synonym) to the embedding 310. Continuing with the previous example, the prompt learning program 150 may apply the random dropout technique 314 to the embedding 310 of training data 3 (“This data is prohibited in the ERP system.”) to generate the new embedding 316 which may include a vector representation of data that is similar to training data 3. In this example, the new embedding 316 may refer to the new text: “This data is banned in the ERP system,” which is semantically similar to the text (“This data is prohibited in the ERP system.”) of training data 3.

According to one embodiment, at event 318, the prompt learning program 150 may train the second ML model 210 on a new dataset including the new embeddings 316 as the training inputs and the original training data 218 of the first ML model training dataset 216 as the outputs. In one embodiment, the prompt learning program 150 may train the second ML model 210 to receive the new embedding 316 as an input (e.g., new training data input), and output the corresponding training data 218 from the first ML model training dataset 216 that is semantically similar to the new embedding 316 (e.g., training output; label). Continuing with the previous example, the prompt learning program 150 may train the second ML model 210 to receive the new embedding 316 (e.g., representing “This data is banned in the ERP system.”) as the new training data input, and to output (e.g., predict) the original training data 3 (“This data is prohibited in the ERP system.”) as the corresponding label that is semantically similar to the new embedding 316.

Thereafter, at event 320, the prompt learning program 150 may generate the fine-tuned second ML model 210 (e.g., fine-tuned pre-trained language model) from the trained second ML model 210. In one embodiment, generating the fine-tuned second ML model 210 may include implementing the trained second ML model 210 from event 318 as the fine-tuned second ML model 210. In one embodiment, the fine-tuned second ML model 210 may then be implemented in the ML environment 200, as described previously with reference to FIG. 2.

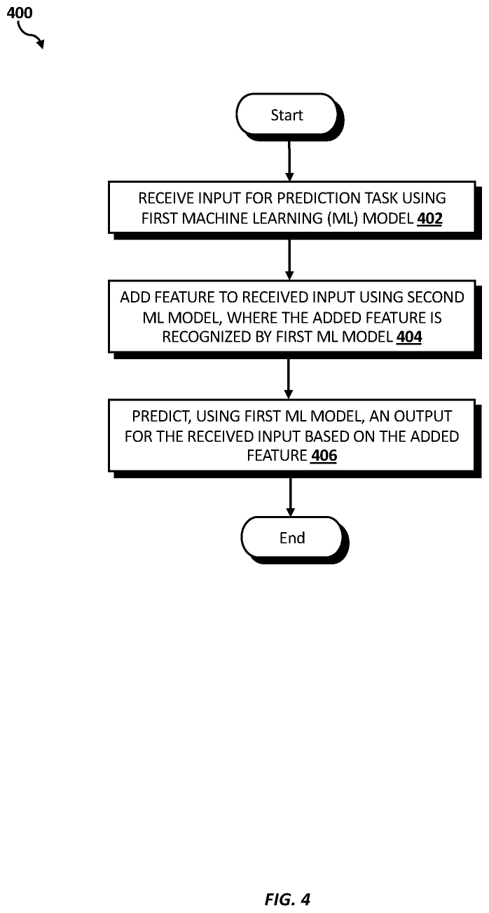

Referring now to FIG. 4, an operational flowchart illustrating an exemplary prompt-learning process 400 used by the prompt learning program 150 according to at least one embodiment is depicted. FIG. 4 provides a description of prompt-learning process 400 with reference to the ML environment 200 (FIG. 2) and the model fine-tuning environment 300 (FIG. 3).

At 402, an input is received for a prediction task using a first machine learning (ML) model. In one embodiment, the prompt learning program 150 may receive the input to perform the prediction task using the first ML model. According to one embodiment, the first ML model may refer to an ML model that is online and deployed for use in a ML environment. In one embodiment, the first ML model may refer to a legacy ML model which may include one or more limitations associated with the received input. In one embodiment, the limitations of the first ML model may decrease the accuracy of a prediction output for the received input.

Then at 404, a feature is added to the received input for the prediction task, where the added feature is recognized by the first ML model. According to one embodiment, the prompt learning program 150 may generate an enriched prediction input using prompt-based learning in conjunction with the second ML model. In one embodiment, the prompt learning program 150 may implement the enriched prediction input to improve an accuracy of the prediction output of the first ML model 206 by including one or more features that may be recognized by the first ML model and may be predictive of the prediction output. In one embodiment, the predicted output by the first ML model based on the added feature may include an improved accuracy relative to another predicted output by the first ML model without considering the added feature.

According to one embodiment, the prompt learning program 150 may leverage the knowledge of the second ML model (e.g., pre-trained language model) and a natural language prompt to perform a text generation NLP task using the second ML model without any task-specific training. More specifically, the prompt learning program 150 may use the prompt template to instruct the second ML model to generate text that is a synonym of the received input. In one embodiment, the synonym of the received input may include data that is semantically similar to the received input.

Therefore, in embodiments of the present disclosure, the prompt learning program 150 may modify the prompt template to include the received input as an input of the prompt template. Then, the prompt learning program 150 may implement the modified prompt template (e.g., the received input, together with the natural-language prompt in the prompt template) to trigger (e.g., instruct) the second ML model to generate the semantically similar data relative to the received input.

It is contemplated that the semantically similar data relative to the received input may help the first ML model in generating the prediction output if the semantically similar data is recognized and/or learned by the first ML model. Accordingly, the prompt learning program 150 may pre-define, for the second ML model, a first ML model training dataset as the possible values for an answer to the task described in the prompt template. In at least one embodiment, the prompt learning program 150 may train (e.g., fine-tune) the second ML model to select the semantically similar data relative to the received input from a training dataset of the first ML model (e.g., first ML model training dataset).

To fine-tune the second ML model, in one embodiment, the prompt learning program 150 may generate a first set of embeddings associated with the training dataset of the first ML model. Then, the prompt learning program 150 may generate a second set of embeddings by applying a random dropout to the generated first set of embeddings. In one embodiment, the generated first set of embeddings and the generated second set of embeddings may be similar in a vector space (e.g., a short distance between the generated first set of embeddings and the generated second set of embeddings in the vector space). In one embodiment, the prompt learning program 150 may train the second ML model using the generated second set of embeddings as training input input and the training dataset of the first ML model as training output (e.g., prediction; label). In one embodiment, for each embedding of the generated second set of embeddings, the trained (e.g., fine-tuned) second ML model may return a corresponding training data from the training dataset of the first ML model.

According to one embodiment, once the second ML model is fine-tuned as described above, the prompt learning program 150 may implement the second ML model to select the semantically similar data relative to the received input from the training dataset of the first ML model. In one embodiment, selecting the semantically similar data using the second ML model may include mapping the received input to a training data of the first ML model, where the training data includes the added feature that is recognized by the first ML model. In one embodiment, the prompt learning program 150 may implement the second ML model to retrieve the training data from the training dataset of the first ML model that is mapped to the received input as the semantically similar data. Then, the prompt learning program 150 may add the retrieved training data to the received input to generate the enriched prediction input such that the enriched prediction input may include one or more features recognized by the first ML model.

Thereafter, at 406, an output is predicted using the first ML model for the received input based on the added feature. In one embodiment, the prompt learning program 150 may implement the first ML model to receive the enriched prediction input to perform the prediction task associated with the received input. In one embodiment, the first ML model may recognize retrieved training data (e.g., the features of the training data) in the enriched prediction input and may generate the prediction output based on the recognized features (and associated label) of training data. In one embodiment, the first ML model may generate the predicted output as the label associated with the features of the training data in the enriched prediction input.

In another embodiment, the prompt learning program 150 may implement the first ML model to receive the answer of the prompt template as the input for performing the prediction task. In this embodiment, the first ML model may receive the training data from the answer slot of the prompt template (e.g., the features of the training data) without the other components of the enriched prediction input (e.g., the original prediction input and the natural-language description of the task). Since the original prediction input and training data of the first ML model dataset were determined to be semantically similar, it is contemplated that the first ML model may perform the prediction task based on the training data of the first ML model dataset. Thus, the first ML model may recognize the training data (e.g., the features of the training data) of the first ML model dataset in the input and may generate the prediction output based on the recognized features (and associated label) of the training data. In one embodiment, the predicted output by the first ML model based on the added feature may include an improved accuracy relative to another predicted output by the first ML model without considering the added feature.

It is contemplated that the prompt learning program 150 may provide several advantages and/or improvements to the technical field of prompt-based ML. The prompt learning program 150 may improve the functionality of a computer because the prompt learning program 150 may enable the computer to generate predictions (using a first ML model) to a new (e.g., unknown) received input with improved accuracy based on one or more recognized features (e.g., of the first ML model) added to the new input using a second ML model. The prompt learning program 150 may enable the computer to generate features that may be recognized by the first ML model and may be semantically similar to the new received input. Since the new received input and the recognized features may be semantically similar, the prompt learning program 150 may enable the computer to perform the prediction task based on recognized features rather than the unknown features of the new received input.

It may be appreciated that FIGS. 2 to 4 provide only an illustration of one embodiment and do not imply any limitations with regard to how different embodiments may be implemented. Many modifications to the depicted embodiment(s) may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving an input for a prediction task using a first machine learning (ML) model;
adding a feature to the received input using a second ML model, wherein the added feature is recognized by the first ML model; and
predicting, using the first ML model, an output for the received input based on the added feature, wherein the predicted output by the first ML model based on the added feature includes an improved accuracy relative to another predicted output by the first ML model without considering the added feature.

2. The computer-implemented method of claim 1, further comprising:
mapping, using the second ML model, the received input to a training data of the first ML model, wherein the training data includes the added feature that is recognized by the first ML model.

3. The computer-implemented method of claim 2, wherein the training data further comprises a label associated with the added feature that is recognized by the first ML model, and wherein the predicted output by the first ML model includes the label of the training data associated with the added feature.

4. The computer-implemented method of claim 1, wherein the first ML model further comprises a deployed ML model, and wherein the second ML model is trained to map the received input to a training data of the first ML model as being semantically similar to the received input.

5. The computer-implemented method of claim 4, wherein predicting the output for the received input based on the added feature further comprises:
receiving, by the first ML model, the training data of the first ML model that is semantically similar to the received input, wherein the received training data includes the added feature that is recognized by the first ML model; and
predicting the output for the received input based on the added feature in the received training data.

6. The computer-implemented method of claim 1, further comprising:
prompting the second ML model to return a semantically similar data relative to the received input; and
selecting, using the second ML model, the semantically similar data relative to the received input from a training dataset of the first ML model.

7. The computer-implemented method of claim 6, further comprising:
modifying a prompt template to include the received input, wherein the modified prompt template triggers the second ML model to generate the semantically similar data relative to the received input; and
retrieving a training data from the training dataset of the first ML model as the semantically similar data relative to the received input, wherein the retrieved training data includes the added feature that is recognized by the first ML model.

8. The computer-implemented method of claim 6, further comprising:
generating a first set of embeddings associated with the training dataset of the first ML model;
generating a second set of embeddings by applying a random dropout to the generated first set of embeddings, wherein the generated first set of embeddings and the generated second set of embeddings are similar in a vector space; and
training the second ML model using the generated second set of embeddings as a training input and the training dataset of the first ML model as a training output, wherein, for each embedding of the generated second set of embeddings, the trained second ML model returns a corresponding training data from the training dataset of the first ML model.

9. A computer system for enhancing deployed machine learning (ML) models using prompt learning, comprising:
one or more processors, one or more computer-readable memories, one or more computer-readable tangible storage media, and program instructions stored on at least one of the one or more computer-readable tangible storage media for execution by at least one of the one or more processors via at least one of the one or more memories, wherein the computer system is capable of performing a method comprising:
receiving an input for a prediction task using a first ML model;
adding a feature to the received input using a second ML model, wherein the added feature is recognized by the first ML model; and
predicting, using the first ML model, an output for the received input based on the added feature, wherein the predicted output by the first ML model based on the added feature includes an improved accuracy relative to another predicted output by the first ML model without considering the added feature.

10. The computer system of claim 9, further comprising:
mapping, using the second ML model, the received input to a training data of the first ML model, wherein the training data includes the added feature that is recognized by the first ML model.

11. The computer system of claim 10, wherein the training data further comprises a label associated with the added feature that is recognized by the first ML model, and wherein the predicted output by the first ML model includes the label of the training data associated with the added feature.

12. The computer system of claim 9, wherein the first ML model further comprises a deployed ML model, and wherein the second ML model is trained to map the received input to a training data of the first ML model as being semantically similar to the received input.

13. The computer system of claim 12, wherein predicting the output for the received input based on the added feature further comprises:
receiving, by the first ML model, the training data of the first ML model that is semantically similar to the received input, wherein the received training data includes the added feature that is recognized by the first ML model; and
predicting the output for the received input based on the added feature in the received training data.

14. The computer system of claim 9, further comprising:
prompting the second ML model to return a semantically similar data relative to the received input; and
selecting, using the second ML model, the semantically similar data relative to the received input from a training dataset of the first ML model.

15. The computer system of claim 14, further comprising:
modifying a prompt template to include the received input, wherein the modified prompt template triggers the second ML model to generate the semantically similar data relative to the received input; and
retrieving a training data from the training dataset of the first ML model as the semantically similar data relative to the received input, wherein the retrieved training data includes the added feature that is recognized by the first ML model.

16. The computer system of claim 14, further comprising:
generating a first set of embeddings associated with the training dataset of the first ML model;
generating a second set of embeddings by applying a random dropout to the generated first set of embeddings, wherein the generated first set of embeddings and the generated second set of embeddings are similar in a vector space; and
training the second ML model using the generated second set of embeddings as a training input and the training dataset of the first ML model as a training output, wherein, for each embedding of the generated second set of embeddings, the trained second ML model returns a corresponding training data from the training dataset of the first ML model.

17. A computer program product for enhancing deployed machine learning (ML) models using prompt learning, comprising:
one or more computer-readable storage media and program instructions collectively stored on the one or more computer-readable storage media, the program instructions executable by a processor to cause the processor to perform a method comprising:
receiving an input for a prediction task using a first ML model;
adding a feature to the received input using a second ML model, wherein the added feature is recognized by the first ML model; and
predicting, using the first ML model, an output for the received input based on the added feature, wherein the predicted output by the first ML model based on the added feature includes an improved accuracy relative to another predicted output by the first ML model without considering the added feature.

18. The computer program product of claim 17, further comprising:
mapping, using the second ML model, the received input to a training data of the first ML model, wherein the training data includes the added feature that is recognized by the first ML model.

19. The computer program product of claim 17, further comprising:
prompting the second ML model to return a semantically similar data relative to the received input; and
selecting, using the second ML model, the semantically similar data relative to the received input from a training dataset of the first ML model.

20. The computer program product of claim 19, further comprising:
generating a first set of embeddings associated with the training dataset of the first ML model;
generating a second set of embeddings by applying a random dropout to the generated first set of embeddings, wherein the generated first set of embeddings and the generated second set of embeddings are similar in a vector space; and
training the second ML model using the generated second set of embeddings as a training input and the training dataset of the first ML model as a training output, wherein, for each embedding of the generated second set of embeddings, the trained second ML model returns a corresponding training data from the training dataset of the first ML model.
